(19) United States
(12) Patent Application Publication
(10) Pub. No.: US 2007/0189300 A1
(43) Pub. Date: Aug. 16, 2007

(54) Charging for multimedia services

(76) Inventors: Mauro Bellora, Gallarate (IT); Gianluca Di Pasquale, Milano (IT); Chiara Dotti, Milano (IT); Goran Eriksson, Sundbyberg (SE); Christer Edlund, Huddinge (SE)

Correspondence Address: ALBIHNS STOCKHOLM AB, BOX 5581, LINNEGATAN 2, SE-114 85 STOCKHOLM; SWEDENn, STOCKHOLM, SE

(21) Appl. No.: 10/571,102

(22) PCT Filed: Aug. 24, 2004
(86) PCT No.: PCT/EP04/51888

§ 371 Date: Jan. 2, 2007

(30) Foreign Application Priority Data
Sep. 12, 2003 (GB) 0321416.0

(51) Int. Cl. H04L 12/56

(52) U.S. Cl. 370/395.2

(57) ABSTRACT

According to the present invention there is provided a method of charging for a combinational multimedia service making use of circuit switched and packet switched services between participating user terminals and an IP Multimedia Subsystem, IMS, responsible for setting-up and controlling packet switched sessions, the method comprising: sending packet switched data generated by a first of the terminals, from a gateway node of a packet switched access network to the or each other terminal via a routing node having an IP address/port-number known a priori; and configuring a charging function associated with said gateway node to zero-rate data destined for said fixed IP address/port-number.

### FIELD OF THE INVENTION

The present invention relates to a method and apparatus for charging for multimedia services provided to users of a wireless communication network and in particular to combinational IP multimedia services, which make use of packet switched and circuit switched connections.

### BACKGROUND TO THE INVENTION

IP Multimedia (IPMM) services provide a dynamic combination of voice, video, messaging, data, etc. within the same session. By growing the numbers of basic applications and the media which it is possible to combine, the number of services offered to the end users will grow, and the inter-personal communication experience will be enriched. This will lead to a new generation of personalized, rich multimedia communication services, including so-called “combinational IP Multimedia” services which are considered in more detail below.

IP Multimedia Subsystem (IMS) is the technology defined by the Third Generation Partnership Project (3GPP) to provide IP Multimedia services over 3G mobile communication networks (3GPP TS 23.228 and TS 24.229 Release 5 and Release 6). IMS provides key features to enrich the end-user person-to-person communication experience through the integration and interaction of services. IMS allows new rich person-to-person (client-to-client) as well as person-to-content (client-to-server) communications over an IP-based network. The IMS makes use of the Session Initiation Protocol (SIP) to set up and control calls or sessions between user terminals (or user terminals and web servers). The Session Description Protocol (SDP), carried by SIP signaling, is used to describe and negotiate the media components of the session. Others protocols are used for media transmission and control, such as Real-time Transport Protocol/Real-time Transport Control Protocol (RTP/RTCP), Message Session Relay Protocol (MSRP), Hyper Text Transfer Protocol (HTTP). IMS requires an access network which would typically be a 2G/3G General Packet Radio Service (GPRS)/Packet Switched (PS) network, but which might be some other access network such as fixed broadband or WiFi. FIG. 1 illustrates schematically how the IMS fits into the mobile network architecture in the case of a GPRS access network.

An example of a combinational IP Multimedia service is a multimedia service that includes and combines both a Circuit Switched media (such as voice) and a Packet Switched media over the IP Multimedia domain (such as pictures, video, presence, instant messages, etc.). A service referred to here as “WeShare” combines the full IP Multimedia Subsystem (IMS) benefits of a multimedia service with CS voice. The service enables an end-user during a (full-duplex) Circuit Switched (CS) voice conversation to immediately share content with another end-user. Such contents may include (but is not limited to):

a picture taken during the conversation with the terminal's inbuilt camera, or a pre-store picture (WeShare Image service);

a one-way live video of, for example, the immediate physical surroundings, captured during the conversation with the terminal's inbuilt camera (WeShare Motion/Clip service);

a pre-stored video clip with a sequence recorded previously, or a clip downloaded from the Web (WeShare MotionNideo service).

Either party in the conversation may initiate transmission of content to the other party.

The charging model for WeShare services must be fair and easy to understand for the user/subscriber if the market take-up of the services is to be high. Subscriber charges for WeShare will likely be based on a combination of:
Standard CS voice charging (i.e. typically time-based);
The actual content shared by means of the IMS. For example, for the WeShare Image service, content charging could be on a per image basis (i.e. event-based); for the WeShare Motion/Clip service, content charging could be on a per clip basis (i.e. event-based); for the WeShare MotionNideo service, content charging could be on a per video basis (i.e. event-based) or on a video-duration basis (i.e. time-based).

Volume based charging (i.e. per Kbits), i.e. PS bearer-level charging, should not apply to WeShare services as this is likely to lead to confusion amongst subscribers. In other words, PS bearer-level charging should be zero-rated (disabled) for IMS-based WeShare services. Content charging for WeShare services should occur at the IMS layer, with the Charging System using charging data (CDR or accounting information) provided by IMS nodes. In order to eliminate PS bearer-level charging for WeShare services, PS bearer-level and IMS session-level charging correlation must be achieved.

3GPP has currently identified three mechanisms for differentiating charging in PS-based and IMS-based networks. These are:
APN (Access Point Name);
The Go interface (between P-CSCF/PCF and GGSN) to correlate PS bearer-level and IMS sessionlevel charging; and
IP-flow bearer level charging (a.k.a. Flow Based Charging) with dynamic filters, to intercept and (zero) rate in the PS domain the user-to-user (user-plane) traffic associated with or related to the IMS session.

Unfortunately, none of these mechanisms is applicable to the early IMS deployment and as such to WeShare services.

With the APN approach, in order to simplify terminals and network configurations, most network operators want to use only one APN for all PS-based services. Thus, the same GPRSIPS PDP context would be used to carry IMS signaling traffic, IMS user-plane traffic, IMS-related end-user management traffic (e.g. HTTP-based traffic for end-user management of contact-list and other user information in the SIP Application Sever), and traffic related to any other PS-based services such as WAP/web browsing, e-mail, MMS, etc. Even if operators are willing to introduce a dedicated APN for IMS services, there may be other, non-WeShare IMS services where both PS bearer-level and IMS-session level charging could be needed to determine the IMS service charging.

With the Go interface, charging correlation is achieved by means of GPRS Charging IDs (related to a given PDP context) and IMS Charging IDs (related to a given IMS/SIP session) exchanged between the PS layer (GGSN) and the IMS layer (P-CSCF/PCF). The Go interface only works when two or more PDP contexts (one primary and one or more secondary PDP contexts), i.e. two or more PS RABs, are used, while only one PS RAB is available for early IMS deployment. In fact, once a GPRS Charging ID has been linked to an IMS Charging ID for the purpose of disabling, at the Charging System, the PS charging input (CDRs or accounting information), then all traffic using that PDP context will not be charged for: this may include traffic related to PS-based services such as WAP/web browsing, e-mail, etc, which operators will want to charge for.

The IP-flow bearer level charging with dynamic filters is in an early standardization phase, and as such will not be available for early WeShare services deployment.

In summary, the problem with the existing technology is how to “zero-out” (zero-rate) the PS bearer-level charging for the IMS-based WeShare related traffic (both signaling and user-plane), whilst still allowing PS bearer-level charging for other PS-based related traffic, while the same APN (and GPRS/PS PDP Context) is used for both IMS and other PS-based traffic.

### SUMMARY OF THE PRESENT INVENTION

According to the present invention there is provided a method of charging for a multimedia service provided over an IP Multimedia Subsystem, IMS, responsible for providing and managing packet switched services, the method comprising:
sending packet switched data generated by a user terminal, from a gateway node of a packet switched access network to an intermediate, proxy, or end-point node having an a-priori known IP address and port-number; and
configuring a charging function associated with said gateway node or a further gateway node in the transmission path to zero-rate data destined for or received from said known IP address and port-number.

Typically, said charging function generates charging data for transmission to a charging system responsible for debiting/crediting subscriber accounts. The charging system also receives charging data from charging functions provided at nodes of the IMS.

Preferably, said multimedia service involves at least two user terminals, a gateway node associated with each user terminal, and, provided between the gateway nodes, an intermediate node having a known IP address/port number.

Said packet switched data may be SIP signalling data, user-plane data, or end-user management data. In the case of user-plane data (media and media control signalling), said node may be a Media Resource Function Processor (MRFP) node or an Message Session Relay Protocol (MSRP) Relay/End-point node. In the case of SIP signalling data, said node may be a Proxy-Call Session Control Function (P-CSCF) node of the IMS. In the case of end-user management data, said node may be an Application Server.

In certain embodiments of the present invention, said packet switched access network is a General Packet Radio Service (GPRS) network, and said gateway nodes are a Gateway GPRS Support Nodes (GGSN)s. Both or all user terminals may use GPRS networks to access the packet switched services. Said charging function may be implemented at the GGSN or at a standalone node coupled to the GGSN.

Preferably, said charging function is arranged to store said known IP address/port-number and to compare this IP address/port-number with the source and/or destination IP address/port-number of the packets passing through the gateway node. Said charging function may perform storing and matching on additional fields of a packet.

According to the present invention there is provided a method of charging for an IP Multimedia Service at a charging function associated with a gateway node of a packet switched access network, the method comprising:
storing at the charging function a set of IP addresses/port-numbers being known a priori, the IP addresses/port-numbers being allocated to one or more nodes of the IP Multimedia Service core network;
filtering IP packets to determine whether the source and/or destination IP address/port-numbers of a packet matches one of the stored addresses/port-numbers; and
zero-rating traffic for which a match is found otherwise applying the usual charging rules.

The charging function may be implemented at the gateway node, e.g. a GGSN, or at a standalone node coupled to the gateway node.

### BRIEF DESCRIPTION OF THE DRAWINGS

FIG. 1 illustrates schematically a network architecture including an IMS core network;

FIG. 2 illustrates schematically an architecture for zero-rating PS bearer-level charging in the case of an WeShare service; and

FIG. 3 illustrates schematically an alternative architecture for zero-rating PS bearer-level charging in the case of an WeShare service.

### DETAILED DESCRIPTION OF CERTAIN EMBODIMENTS OF THE INVENTION

The set of services referred to here as “WeShare” has been described above, and that term is used here by way of example. Of course the inventive principles identified can be applied to other combinational multimedia services, which may be known by some other name.

It is proposed here to share content (image, clip, video, etc.) between the partes engaged in a WeShare service session by directing the content through an intermediate network node which handles user-plane traffic. The intermediate node behaves as a bridge between the two users sharing content: that is the node shall take the media content from a first of the terminals, user agent (UA) A, and transfer it to the second terminal, user agent (UA) B, and vice versa. In this example, the transfer node is a Media Resource Function (MRF), specifically a Media Resource Function Processor (MRFP) controlled by a Media Resource Function Controller (MRFC). The MSRP protocol is set out in “IETF draft-ietf-simple-message-sessions-07” and “IETF draft-ietf-simple-msrp-relay-01”.

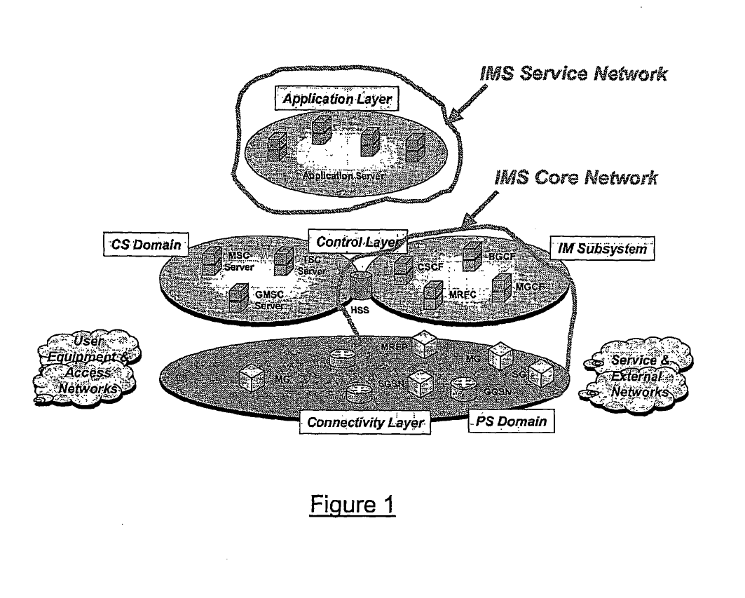

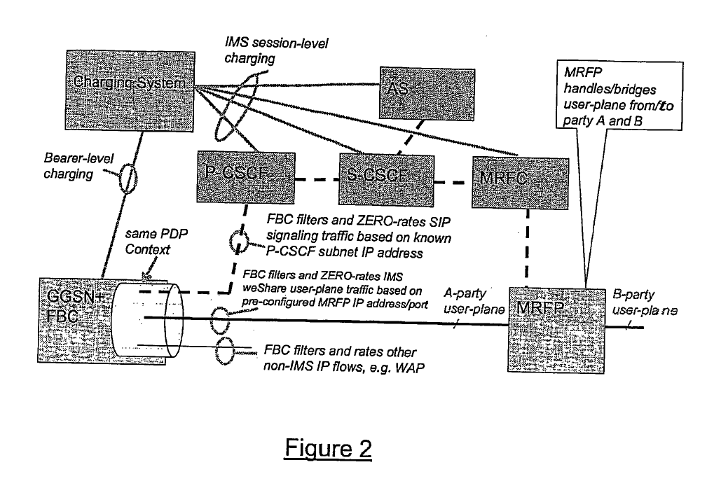

This architecture is illustrated in FIG. 2, where the MRFC communicates with Charging System. The MRF is selected from a pool of MRFs each of which is allocated a (set of) static IP address/port-number, and all user plane traffic associated with the WeShare service is “forced” through the selected MRF. Also illustrated in FIG. 1 are the P-CSCF and S-CSCF, as well as a SIP AS. (The SIP-AS may be required to provide the logic for including the MRF in the user-plane path.)

A GPRS Gateway Support Node (GGSN) provides a gateway between the packet switched access network of a first of the users (e.g. UE-A) and the IMS network. A similar gateway node (not shown in FIG. 2) is provided between the access network of the other user (UE-B), and the IMS network. The GGSN communicates with the Charging System and would, in the absence of a zero-rating operation, send volume related charging information to the charging system.

It is desirable to zero-rate all traffic (SIP signalling, media control signalling, and media, and possibly contact-list/other end-user information management) associated with an IMS (WeShare) service at the packet-switched level, so that charging occurs only at the IMS layer, thus avoiding the double-charging of users for both data volume (e.g. Mbits/second) and IMS level content (e.g. pictures, video clips, etc). This traffic includes SIP signalling traffic to/from the P-CSCF, media control signalling and the actual media traffic (e.g. RTCP/RTP traffic for video; MSRP traffic for image/clip) to/from the MRF.

To achieve this zero-rating, a charging filter known as a Flexible Bearer Charging (FBC) with static filter is implemented at the GGSN (although it may be implemented as a standalone node connected to the GGSN over the “Gi” interface). The FBC static filter is configured with the P-CSCF subnet IP address/port-number (known a priori). All SIP signalling can be intercepted and zero-rated at this filter. In addition, the filter is configured with the MRF subnet IP address/port-number (also known a priori), allowing all IMS related RTPC/RTP or MSRP traffic to be intercepted and zero-rated. The filter may be further configured with the subnet IP address/port-number (known a priori) of the SIP-AS in charge of contact-list/other end-user information management, allowing such management traffic to be zero-rated. Further details of the FBC can be found in 3GPP TR 23.825.

The MRF (MRFP via MRFC) provides charging input (accounting information) to the charging system. Also, other IMS nodes such as the CSCFs and SIP-AS may provide charging input to the charging system, e.g. when session-time is needed for charging determination.

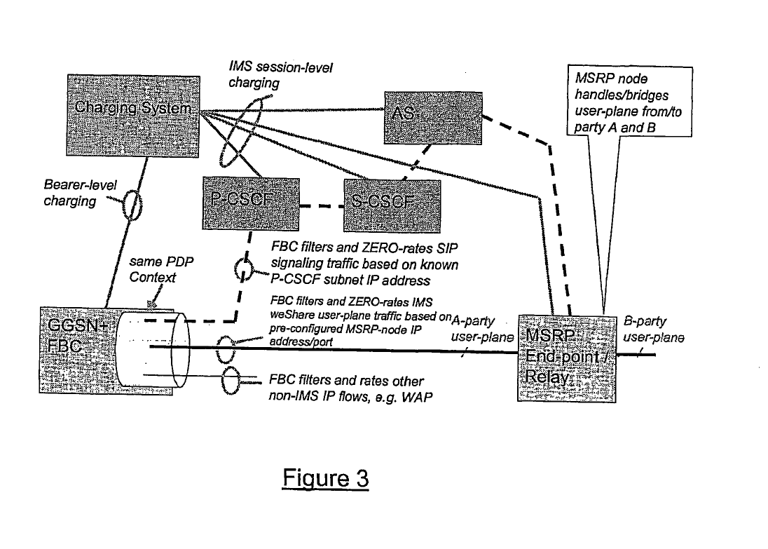

FIG. 3 illustrates an alternative architecture in which the MRF is replaced by an Message Session Relay Protocol (MSRP) node, behaving as either End-point or Relay.

The described solution allows for an early deployment of IMS-based WeShare services with a suitable charging model such that the user/subscriber knows exactly what he/she is paying for, e.g. a given amount of money for each image sent when using the WeShare Image service.

### Abbreviations Used in this Document Include

3GGP 3^{rd} Generation Partnership Project
WCDMA Wideband Code Division Multiple Access
GPRS General Packet Radio Services
3G 3^{rd} Generation Network
IMS 3GPP IP Multimedia Subsystem
IPMM IP Multimedia (IMS-based)
PS Packed Switched
CS Circuit Switched
RAB (WCDMA) Radio Access Bearer
MRF Media Resource Function
MRFC Media Resource Function Control
MRFP Media Resource Function Processor
FBC Flexible Bearer Charging
CDR Call Detailed Record
MSRP Message Session Relay Protocol
APN Access Point Name
IP Internet Protocol
WeShare Instant Share

1. A method of charging for a multimedia service provided over an IP Multimedia Subsystem, IMS, responsible for providing and managing packet switched services, the method comprising:
sending packet switched data generated by a user terminal, from a gateway node of a packet switched access network to an IP destination node, via an intermediate node having an IP address/port-number known a priori; and
configuring a charging function associated with said gateway node or a further gateway node in the transmission path to zero-rate data destined for or received from said known IP address/port-number.

2. A method according to claim 1, wherein said charging function generates charging data for transmission to a charging system responsible for debiting/crediting subscriber accounts.

3. A method according to claim 1, wherein said multimedia service involves at least two user terminals, a gateway node associated with each user terminal, and, provided between the gateway nodes, an intermediate node having a known IP address/port number.

4. A method according to claim 1, wherein said packet switched data is media and/or media control signalling and said node having an IP address/port-number known a priori is a Media Resource Function Processor node or a Message Session Relay Protocol End-point or Relay node.

5. A method according to claim 1, wherein said packet switched data is signalling data and said node having an IP address/port-number known a priori is a Proxy-Call Session Control Function node.

6. A method according to claim 1, wherein said packet switched data is signalling data and said node having an IP address/port-number known a priori is a SIP Application Server for contact-list and other end-user information management.

7. A method according to claim 1, wherein said packet switched access network is a General Packet Radio Service (GPRS) network, and said each gateway node is a Gateway GPRS Support Nodes (GGSN)s.

8. A method according to claim 7, wherein said charging function is implemented at the GGSN or at a standalone node coupled to the GGSN.

9. A method according to claim 1, comprising storing said know IP address/port number at the charging function and comparing this address with the source and/or destination address/port-numbers of IP packets passing through a gateway node, and zero-rating data for which a match is found.

10. A method of charging for an IP Multimedia Service at a charging function associated with a gateway node of a packet switched access network, the method comprising:
storing at the charging function a set of IP addresses/port-numbers being known a priori, said IP addresses/port-numbers being allocated to one or more nodes of the IP Multimedia Service core network;
filtering IP packets to determine whether the source and/or destination address of a packet matches one of the stored addresses; and
zero-rating traffic for which a match is found otherwise applying the usual charging rules.

11. A method according to claim 10, wherein said access network is a GPRS access network, and the charging function is implemented at a GPRS Gateway Support Node or at a standalone node coupled to the GPRS Gateway Support Node.

12. A method according to claim 2, wherein said packet switched data is signalling data and said node having an IP address/port-number known a priori is a SIP Application Server for contact-list and other end-user information management.
